(19) United States
(12) Patent Application Publication
(10) Pub. No.: US 2006/0274708 A1
(43) Pub. Date: Dec. 7, 2006

(54) System and method for wireless communication

(76) Inventors: Eduardo Lopez Estraviz, Valdovino (ES); Francois Horlin, Brussel (BE)

Correspondence Address: KNOBBE MARTENS OLSON & BEAR LLP, 2040 MAIN STREET, FOURTEENTH FLOOR, IRVINE, CA, 92614, US

(21) Appl. No.: 11/433,629

(22) Filed: May 12, 2006

(30) Foreign Application Priority Data
May 13, 2005 (EP) 05447109.9

(51) Int. Cl. H04B 7/216

(52) U.S. Cl. 370/342

(57) ABSTRACT

One disclosed inventive aspect is related to a method for wireless transmission of a sequence of data symbols from a transmitter to a receiver, wherein the transmitter is provided with at least two TX antennas. The method comprises converting the sequence of data symbols into at least one stream of blocks of independent data symbols to be transmitted, performing a block coding operation on the at least one stream of data symbol blocks, yielding a coded block of data symbols on each of the at least two antennas, applying a spreading operation on each data symbol of the coded block of data symbols, yielding spread coded blocks, adding transmit redundancy to the spread coded blocks, and transmitting the spread coded blocks with transmit redundancy.

### BACKGROUND OF THE INVENTION

1. Field of the Invention

The present invention relates to the field of 4G cellular wireless communication systems and air interfaces therefor.

2. Description of the Related Technology

In order to meet the high data rate and quality-of-service (QoS) requirements of the future broadband cellular systems, it is widely accepted that multiple antenna techniques should be used in combination with newly designed air interfaces.

Cellular systems of the third generation (3G) are based on the direct-sequence code division multiple access (DS-CDMA) technique. DS-CDMA increases the system's intrinsic capacity and offers interesting networking capabilities. First, the communicating users do not need to be time synchronised in the uplink. Second, soft hand-over is supported between two cells employing different codes at the base stations. However, the system suffers from inter-symbol interference (ISI) and multiuser interference (MUI) caused by multipath propagation, leading to a significant performance loss.

In order to enable the design of low complexity transceivers that can cope with multipath channels, next generation cellular systems can combine the DS-CDMA accessing scheme with the single-carrier block transmission (SCBT), also known as single-carrier (SC) modulation with cyclic prefix (see ‘Comparison between adaptive OFDM and single carrier modulation with frequency domain equalization’, A. Czylwik, IEEE Proc. of VTC, May 1997, pp. 865-869.). Similarly to orthogonal frequency division multiplexing (OFDM), SCBT transforms a time dispersive channel into a set of parallel independent flat sub-channels that can be equalized at a low complexity. Since the SCBT technique benefits from a low peak-to-average power ratio (PAPR), it has been recognised as an interesting alternative to OFDM in the uplink, that could significantly reduce the constraints on the analogue front-end as well as the processing complexity at the terminal. DS-CDMA is applied on top of the SCBT equalized channel. The DS-CDMA signals are either spread across the single-carrier sub-channels, leading to single-carrier CDMA (SC-CDMA) (see Vollmer et al., ‘Comparative study of joint detection techniques for TD-CDMA based mobile radio systems’, IEEE J. on Sel. Areas in Comm., vol. 19, no. 8, pp. 1461-1475, August 2001), or across the SCBT blocks, leading to single-carrier block-spread CDMA (SCBS-CDMA). SC-CDMA and SCBS-CDMA can be seen the SC counter-parts of multi-carrier CDMA (MC-CDMA) and multi-carrier block-spread CDMA (MCBS-CDMA), respectively. SCBS-CDMA preserves the orthogonality amongst the users, regardless of the underlying multipath channel, which enables perfect user separation through low complexity code correlation. It entails however a larger symbol latency than SC-CDMA, that makes it impractical in medium-to-high mobility cellular environments. For time-selective channels, SC-CDMA is the only viable air interface.

Multiple-input multiple-output (MIMO) systems, which deploy multiple antennas at both ends of the wireless link, explore the extra spatial dimension, besides the time, frequency, and code dimensions, to significantly increase the spectral efficiency and to improve the link reliability relative to single antenna systems. In this context, space-time block coding (STBC) has gained a lot of attention as an effective transmit diversity technique to combat fading in wireless communications. Orthogonal space-time (ST) block codes for two transmit antennas have first been introduced by Alamouti (‘A simple transmit diversity technique for wireless communications’, IEEE Journal on Selected Areas in Communications, vol. 16, no. 8, October 1998) and has later been generalised to an arbitrary number of transmit antennas. The ST codes are initially designed for frequency flat fading channels. Therefore, the time reversal (TR) STBC technique has been proposed as an extension to frequency selective channels. These designs have remarkably simple maximum-likelihood (ML) decoding algorithms based on linear processing at the receiver. In specific cases of two or four transmit antennas, these diversity schemes provide full and three-quarters of the maximum possible transmission rate, respectively.

The combination of STBC with the SC-based air interfaces has only been addressed very recently. The paper ‘Space-time block-coding for single-carrier block transmission DS-CDMA downlink’ (F. Petré et al., IEEE J. on Sel. Areas in Comm., Special issue on MIMO Systems and Applications, vol. 21, no. 3, pp. 350-361, April 2003) first combines STBC and SCBS-CDMA. Since the SCBS-CDMA scheme is orthogonal in the users (both for uplink and downlink), deterministic ML user separation through low-complexity code matched filtering and ML ST multi-stream separation through linear decoding can be consecutively applied without any performance loss with respect to the optimal ML joint multi-user detector and ST block decoder. On the other hand, e.g. Vook et al. (‘Cyclic-prefix CDMA with antenna diversity’, IEEE Proceedings of VTC Spring, May 2002, vol. 2, pp. 1002-1006) combine STBC and SC-CDMA. The TR STBC technique is applied at the chip level, on the signals resulting from the CDMA spreading (see FIG. 1, where a downlink scenario is asumed). The receiver, intuitively composed of the counter-part of each operation at the transmitter, performs first the STBC decoding and the inversion of the channels, followed by the CDMA user despreading (FIG. 1). Since multiple channels cannot be inverted at the same time, this method is only applicable to the downlink. For the same reason, the transmit antenna symbol streams are not orthogonal in the uplink.

Patent application EP1357693A1 discloses a method for multi-user wireless communication of data signals. The method focuses on the downlink bottleneck. In the method a spreading across a number of symbol blocks is performed. It implicitly assumes the channel remains constant over a number of symbol blocks.

It is thus desirable to provide a method for wireless transmission and a corresponding method for reception of a data symbol sequence that overcome the problems of the prior art, specifically with respect to latency.

### SUMMARY OF CERTAIN INVENTIVE ASPECTS

Certain inventive aspects relate to a method for wireless transmission of a sequence of data symbols from a transmitter to a receiver, whereby the transmitter is provided with at least two transmit antennas. The method comprises the following steps:
Converting (e.g. serial-to-parallel conversion) the sequence of information symbols into at least one stream of blocks of independent data symbols to be transmitted,
performing a block coding operation on said at least one stream of data symbol blocks, yielding a coded block of data symbols on each of the at least two antennas,
applying a spreading operation on each data symbol of the coded block of data symbols, yielding spread coded blocks,
adding transmit redundancy to the spread coded blocks, and
transmitting the spread coded blocks with transmit redundancy.

In a most preferred embodiment the block coding operation is a space-time block coding operation, implemented by coding the various transmit antenna streams across a number of time instants. In a scheme with two transmit antennas for example, the transmitted block at time instant n+1 from one antenna is the time-reversed conjugate of the transmitted symbol at time instant n from the other antenna (with possible permutation and sign change). This property allows for deterministic transmit stream separation at the receiver, regardless of the underlying frequency selective channels.

Advantageously the steps of the method are performed for a plurality of users, each user being connected to a user-specific terminal.

The spreading operation is preferably performed with a user-specific code sequence. The step of adding transmit redundancy typically comprises the addition of a cyclic prefix. It is important to note that in the approach according to certain inventive aspects, the symbol spreading is performed on the block coded data blocks.

The transmitter provided with at least two antennas preferably is a terminal and the receiver a base station.

Certain inventive aspects also relate to a method for wireless reception of block coded data transmitted, for a plurality of users, by a plurality of transmitters, whereby each of the transmitters is provided with at least two transmit antennas. The method comprises the steps of:
separating the received block coded data in a number of received data streams, said number dependent on the block coding applied on the blocks of data in the transmitters, said received data streams comprising block coded blocks of data from different users and different transmit antennas, and
performing on the block coded blocks of data comprised in said number of received data streams a computation step to order the received data per user and per transmit antenna, said computation step comprising a block decoding and an intrablock despreading operation, whereby said computation step divides each of the block coded blocks of data into sub-channels, said block coded blocks of data subsequently being combined per sub-channel, yielding a single combined data stream of per sub-channel blocks of data, ordered per user and per transmit antenna.

Advantageously the method comprises the further steps of
cancelling interference by combining, for each of the sub-channels, data in the single combined data stream of per sub-channel blocks of data corresponding to only one sub-channel, yielding interference cancelled per sub-channel blocks of output data,
transforming the interference cancelled per sub-channel blocks of output data over all sub-channels, yielding transformed interference cancelled blocks of output data,
reordering the transformed interference cancelled blocks of output data per user and per transmit antenna.

Preferably the step of dividing into sub-channels is performed by means of a plurality of FFT's. The step of transforming is typically carried out with an inverse FFT operation.

In a preferred embodiment the computation step comprises a phase correction on each of the sub-channels. The interference cancellation step may comprise an amplitude equalization on each of the sub-channels.

In a specific embodiment a plurality of received antennas is used for receiving the block coded data.

Another inventive aspect relates to a transmit device for wireless communication, performing the method for wireless transmission as previously described.

Certain inventive aspects further relate to a transmit device for wireless transmission of at least one stream of blocks of data. The transmit device is provided with at least two transmit antennas and further comprises block coding means to perform a block coding operation on the at least one stream of blocks of data. The block coding means thereby output a coded block of data on each of the at least two antennas. The transmit device further comprises spreading means to spread the coded block of data on each of the at least two antennas.

Another inventive aspect relates to a receiver device for wireless communication, performing the above described method for wireless reception.

Another inventive aspect relates to a receiver device for wireless reception of block coded data transmitted, for a plurality of users, by a plurality of transmitters, each of the transmitters being provided with at least two transmit antennas. The receiver device comprises at least one receive antenna, separating means for separating the received block coded data in a number of received data streams, and further, for each of the received data streams, means for block decoding and block despreading.

In a preferred embodiment the receiver device further comprises interference cancellation means arranged for cancelling interference on a sub-channel per sub-channel basis.

### BRIEF DESCRIPTION OF THE DRAWINGS

FIG. 1 represents a prior art scheme.

FIG. 2 represents a transceiver scheme according to one inventive embodiment.

FIG. 3 represents the transmitter model.

FIG. 4 represents the receiver model.

FIG. 5 represents a receiver model arranged for dealing with a dynamic environment.

FIG. 6 represents the BER as a function of the received E_{b}/N₀.

FIG. 7 represents the BER as a function of the number of users.

### DETAILED DESCRIPTION OF CERTAIN ILLUSTRATIVE EMBODIMENTS

Certain inventive embodiments relate to a method to combine STBC and SC-CDMA, applicable in the uplink as well as in the downlink. The STBC coding is applied at the symbol level, before the CDMA spreading. The scheme preserves the orthogonality between the transmit antenna symbol streams. At the receiver, a low complexity joint multi-user detector and ST block decoder, optimized according to the minimum mean square error (MMSE) criterion, is proposed.

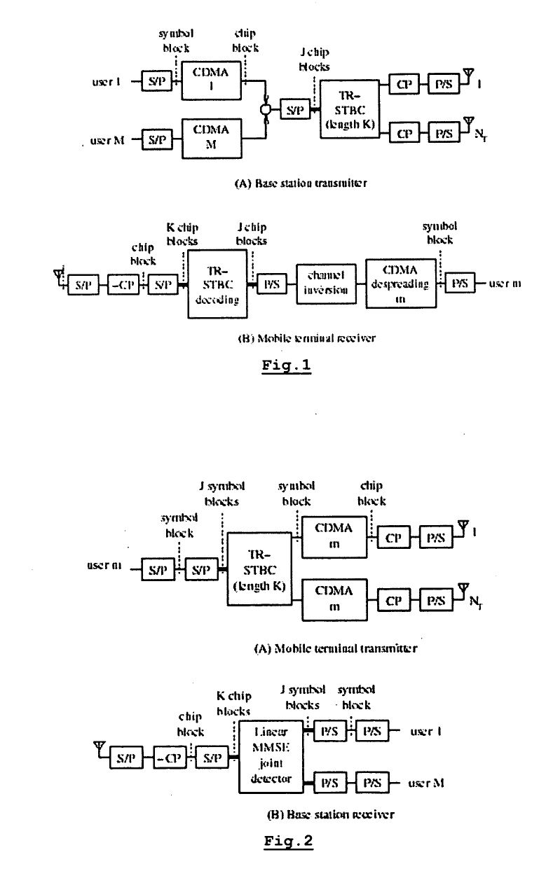

FIG. 2 shows a general scheme according to one inventive embodiment for an uplink scenario, i.e. from a user-terminal to a base station. As can be seen in FIG. 2, the order of the CDMA and the STBC blocks have changed as compared to the scheme in FIG. 1.

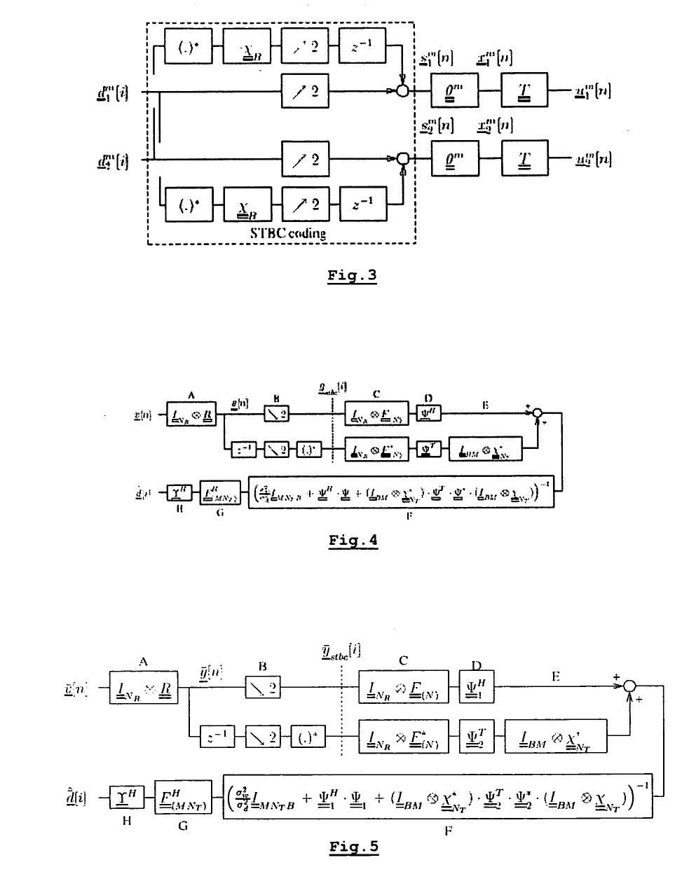

A transmission scheme for the m-th user (m=1, . . . , M) is depicted in FIG. 3. Each user sends its data through a plurality of transmit antennas. The information symbols, dₙ_{_{T}}^{m}[i] (n_{T}=1, . . . , N_{T}), which are assumed independent and of variance equal to σ_{d}², are first serial-to-parallel converted into blocks of B symbols, leading to the symbol block sequence dₙ_{_{T}}^{m}[i]:=[dₙ_{_{T}}^{m}[iB] . . . dₙ_{_{T}}^{m}[(i+1)B−1]]^{T}.

For conciseness the case of N_{T}=2 transmit antennas is considered and the STBC scheme proposed by Alamouti is extended to the uplink of a SC-CDMA-based communication system. However the developments can be extended to any number of antennas by using the orthogonal coding designs (see Tarokh et al., ‘Space-time block codes from orthogonal designs’, IEEE Trans. on Information Theory, vol. 45, pp. 1456-1467, July 1999).

An STBC technique is implemented by coding the two antenna streams across two time instants, as follows:

$$\begin{matrix}[ \begin{matrix}{\underline{s}}_{1}^{m} [ n ] \\ {\underline{s}}_{2}^{m} [ n ]\end{matrix} ] = [ \begin{matrix}{\underline{d}}_{1}^{m} [ i ] \\ {\underline{d}}_{2}^{m} [ i ]\end{matrix} ] & ( eq . 1 ) \\ [ \begin{matrix}{\underline{s}}_{1}^{m} [ n + 1 ] \\ {\underline{s}}_{2}^{m} [ n + 1 ]\end{matrix} ] = \underline{\underline{χ}} \cdot [ \begin{matrix}{{\underline{d}}_{1}^{m} [ i ]}^{*} \\ {{\underline{d}}_{2}^{m} [ i ]}^{*}\end{matrix} ] & ( eq . 2 )\end{matrix}$$

where i=|n/2|. The coding matrix χ is the result of the Kronecker product of submatrices χ_{N}_{_{T}} and χ_{B}, that implement the simple Alamouti scheme across two antennas in flat fading channels and the additional time-reversal permutation needed for time-dispersive channels, respectively, as expressed in χL=χ_{N}_{_{T}}\textcircled{×}χ_{B}. The Kronecker product of two matrices A=(aᵢⱼ) and C is defined as:

$$\underline{\underline{A}} ⊗ \underline{\underline{C}} \text{:} = [ \begin{matrix}{a}_{11} \underline{\underline{C}} & ⋯ & {a}_{1 n} \underline{\underline{C}} \\ ⋮ & ⋰ & ⋮ \\ {a}_{n 1} \underline{\underline{C}} & ⋯ & {a}_{nn} \underline{\underline{C}}\end{matrix} ] \qquad ( eq . 3 )$$

The submatrices χ_{N}_{T} and χ_{B} are defined as

$$\begin{matrix}{\underline{\underline{χ}}}_{{N}_{T}} \text{:} = [ \begin{matrix}0 & - 1 \\ 1 & 0\end{matrix} ] & ( eq . 4 ) \\ {\underline{\underline{χ}}}_{B} \text{:} = {\underline{\underline{F}}}_{B}^{T} \cdot {\underline{\underline{F}}}_{B} & ( eq . 5 )\end{matrix}$$

where F_{B} is the Fast Fourier transform (FFT) matrix of size B. The coding matrix χ can thus be written as

$$\underline{\underline{χ}} \text{:} = [ \begin{matrix}0 & - {\underline{\underline{χ}}}_{B} \\ {\underline{\underline{χ}}}_{B} & 0\end{matrix} ] \qquad ( eq . 6 )$$

and therefore one obtains

$$[ \begin{matrix}{\underline{s}}_{1}^{m} [ n + 1 ] \\ {\underline{s}}_{2}^{m} [ n + 1 ]\end{matrix} ] = [ \begin{matrix}{\underline{\underline{- χ}}}_{B} \cdot {{\underline{d}}_{2}^{m} [ i ]}^{*} \\ {\underline{\underline{χ}}}_{B} \cdot {{\underline{d}}_{1}^{m} [ i ]}^{*}\end{matrix} ] \qquad ( eq . 7 )$$

The block coding operation as described here may be performed by a block coding module (not shown). The blocking coding module is configured to perform the block coding operation on the at least one stream of blocks of data and output a coded block of data on each antenna. In some embodiments, the block coding module is a processor which may be any suitable general purpose single- or multi-chip microprocessor, or any suitable special purpose microprocessor such as a digital signal processor, microcontroller, or a programmable gate array. As is conventional, the processor may be configured to execute one or more software modules.

The transmitted block at time instant n+l from one antenna is the time-reversed conjugate of the transmitted symbol at time instant n from the other antenna (with possible permutation and sign change). This property allows for deterministic transmit stream separation at the receiver, regardless of the underlying frequency selective channels.

Assuming a scenario with N_{T}=4 transmit antennas and a multiple antenna time coding length 8 (i.e. for each time instant n there is a coding across 8 time instants n, n+1, . . . , n+7) the following scheme could apply, with d_{α}^{m}[i] denoting the symbol block to be transmitted:

| | n | n + 1 | n + 2 | n + 3 | n + 4 | n + 5 | n + 6 | n + 7 |
|---|---|---|---|---|---|---|---|---|
| Ant. 1 | d₁^{m}[i] | −d₂^{m}[i] | −d₃^{m}[i] | −d₄^{m}[i] | χ_{B} · d₁^{m}[i]* | −χ_{B} · d₂^{m}[i]* | −χ_{B} · d₃^{m}[i]* | −χ_{B} · d₄^{m}[i]* |
| Ant. 2 | d₂^{m}[i] | d₁^{m}[i] | d₄^{m}[i] | −d₃^{m}[i] | χ_{B} · d₂^{m}[i]* | χ_{B} · d₁^{m}[i]* | χ_{B} · d₄^{m}[i]* | −χ_{B} · d₃^{m}[i]* |
| Ant. 3 | d₃^{m}[i] | −d₄^{m}[i] | d₁^{m}[i] | d₂^{m}[i] | χ_{B} · d₃^{m}[i]* | −χ_{B} · d₄^{m}[i]* | χ_{B} · d₁^{m}[i]* | χ_{B} · d₂^{m}[i]* |
| Ant. 4 | d₄^{m}[i] | d₃^{m}[i] | −d₂^{m}[i] | d₁^{m}[i] | χ_{B} · d₄^{m}[i]* | χ_{B} · d₃^{m}[i]* | −χ_{B} · d₂^{m}[i]* | χ_{B} · d₁^{m}[i]* |

SC-CDMA first performs classical DS-CDMA symbol spreading, followed by single-carrier block transmission (SCBT) modulation, such that the information symbols are spread across the different SCBT sub-channels. In the approach according to one inventive embodiment, the symbol spreading is performed on the STBC coded data blocks.

The symbol spreading operation as described here may be performed by a spreading module (not shown). The spreading module is configured to spread coded data on each antenna. In some embodiments, the block coding module is a processor which may be any suitable general purpose single- or multi-chip microprocessor, or any suitable special purpose microprocessor such as a digital signal processor, microcontroller, or a programmable gate array. As is conventional, the processor may be configured to execute one or more software modules. In some embodiments, the symbol spreading module and the block coding module may be combined.

With N denoting the spreading code length and Q=BN, the Q×B spreading matrix θ^{m} that spreads the symbols across the subchannels, is defined as:
θ^{m}:=I_{B}\textcircled{×}a^{m}, (eq. 8)
with a^{m}:=[a^{m}[0] . . . a^{m}[N−1]]^{T} the m-th user's N×1 code vector and I_{B} the B×B identity matrix. The blocks x_{_{T}}^{m}[n] are obtained by multiplying the blocks sₙ_{_{T}}^{m}[n] with the θ^{m} spreading matrix:
xₙ_{_{T}}^{m}[n]:=θ^{m}·sₙ_{_{T}}^{m}[n]. (eq. 9)

Finally, the K×Q (K≧Q) transmit matrix, T, adds some transmit redundancy to the time-domain chip blocks:
uₙ_{_{T}}^{m}[n]:=T·xₙ_{_{T}}^{m}[n]. (eq. 10)
with K=Q+L, T=T_{cp}:=[I_{cp}^{T},I_{Q}^{T}]^{T}, where I_{Q} is the identity matrix of size Q and L_{cp} consists of the last L rows of L_{Q}, T adds redundancy in the form of a length-L cyclic prefix (CP). The resulting transmitted chip block sequence, uₙ_{T}^{m}[n], is parallel-to-serial converted into the scalar sequence, [uₙ_{_{T}}^{m}[nK] . . . uₙ_{_{T}}^{m}[(n−1)K−1]]^{T}:=u^{m}[n], and transmitted over the air at a rate 1/T_{c}.

After propagation through the different user channels the signal is received—in the most general case—at N_{R} receive antennas. A specific case of high practical importance is obtained by putting N_{R}=1, i.e. for only one receive antenna. Adopting a discrete-time baseband equivalent model, the chip-sampled received signal at antenna n_{R} (n_{R}=1, . . . , N_{R}), vₙ_{_{g}} [n], is the superposition of a channel-distorted version of the MN_{T} transmitted user signals, which can be written as:

$${v}_{{n}_{R}} [ n ] = {\sum }_{m = 1}^{M} {\sum }_{{n}_{T} = 1}^{{N}_{T}} {\sum }_{l = 0}^{{L}^{m}} {h}_{{n}_{R} , {n}_{T}}^{m} [ l ] {u}_{{n}_{T}}^{m} [ n - l ] + {w}_{{n}_{R}} [ n ] , \qquad ( eq . 11 )$$

where hₙ_{_{R}}_{,n}_{_{T}}^{m}[l] denotes the chip-sampled FIR channel impulse response (with length L^{m} taps) that models the frequency-selective multipath propagation between the m-th user's antenna n_{T} and the base station antenna n_{R}, including the effect of transmit/receive filters and the remaining asynchronism of the quasi-synchronous users, and wₙ_{_{R}}[n] is additive white gaussian noise (AWGN) at the base station antenna n_{R} with variance σ_{w}². Furthermore, the maximum channel impulse response length L, i.e. L=max(L^{m}), can be well approximated by L≈└(τ_{max,a}+τ_{max,s})/T_{c}┘+1, where τ_{max,a} is the maximum asynchronism between the nearest and the farthest user of the cell, and τ_{max,s} is the maximum excess delay within the given propagation environment.

Assuming perfect time and frequency synchronization, the received sequence vₙ_{_{R}}[n] is serial-to-parallel converted into the block sequence vₙ_{_{R}}[n]:=[vₙ_{_{R}}[nK] . . . vₙ_{_{R}}[(n+1)K−1]]^{TY}. From the scalar input/output relationship in equation (11), the corresponding block input/output relationship can be derived:

$${\underline{v}}_{{n}_{R}} [ n ] = {\sum }_{m = 1}^{M} {\sum }_{{n}_{T} = 1}^{{N}_{T}} ( {\underline{\underline{H}}}_{{n}_{R} , {n}_{T}}^{m} [ 0 ] \cdot {\underline{u}}_{{n}_{T}}^{m} [ n ] + {\underline{\underline{H}}}_{{n}_{R} , {n}_{T}}^{m} [ 1 ] \cdot {\underline{u}}_{{n}_{T}}^{m} [ n - 1 ] ) + {\underline{w}}_{{n}_{R}} [ n ] \qquad ( eq . 12 )$$

where wₙ_{_{R}}[n]:=[wₙ_{_{R}}[nK] . . . wₙ_{_{R}}[(n+1)K−1]]^{T} represents the corresponding noise block sequence, Hₙ_{_{R}}_{,n}_{T}^{m}[0] is a K×K lower triangular Toeplitz matrix with entries [Hₙ_{_{R}}_{,n}_{_{T}}^{m}[0]]_{p,q}=hₙ_{_{R}}ₙ_{_{T}}^{m}[p−q], and Hₙ_{_{R}}_{,n}_{_{T}}^{m}[1] is a K×K upper triangular Toeplitz matrix with entries [Hₙ_{_{R}}_{,n}_{_{T}}^{m}[1]]_{p,q}=hₙ_{_{R}}_{,n}_{_{T}}^{m}[L+p−q].The delay-dispersive nature of multipath propagation gives rise to so-called inter-block interference (IBI) between successive blocks, which is modeled by the second term in equation (12).

The Q×K receive matrix R removes the redundancy from the chip blocks, i e. yₙ_{_{R}}[n]:=R·vₙ_{_{R}}[n]. With R=R_{cp} =[0_{Q×L}, I_{Q}] in which 0_{Q×L} is a Q×L matrix of zeros, R again discards the length-L cyclic prefix. The purpose of the transmit T/receive R pair is twofold. First, it allows for simple block-by-block processing by removing the IBI, that is, R·Hₙ_{_{R}}_{, n}_{_{T}}^{m}[1]·T=0, provided the CP length is at least the maximum channel impulse response length L. Second, it enables low-complexity frequency-domain processing by making the linear channel convolution to appear circulant to the received block. This results in a simplified block input/output relationship in the time-domain:

$${\underline{y}}_{{n}_{R}} [ n ] = {\sum }_{m = 1}^{M} {\sum }_{{n}_{T} = 1}^{{N}_{T}} {\underline{\underline{{H}^{•}}}}_{{n}_{R} , {n}_{T}}^{m} \cdot {\underline{x}}_{{n}_{T}}^{m} [ n ] + {\underline{z}}_{{n}_{R}} [ n ] \qquad ( eq . 13 )$$

where

$${{\underline{H}}^{•}}_{{n}_{R} , {n}_{T}}^{m} = \underline{\underline{R}} \cdot {\underline{\underline{H}}}_{{n}_{R} {n}_{T}}^{m} [ 0 ] \cdot \underline{\underline{T}}$$

is a circulant channel matrix, and zₙ_{_{R}}[n]=R·wₙ_{_{R}}[n] is the corresponding noise block sequence. It is to be noted that circulant matrices can be diagonalized by FFT operations, that is,

$${{\underline{H}}^{•}}_{{n}_{R} , {n}_{T}}^{m} = {\underline{\underline{F}}}_{Q}^{H} \cdot {\underline{\underline{Λ}}}_{{n}_{R} , {n}_{T}}^{m} \cdot {\underline{\underline{F}}}_{Q} , where {\underline{\underline{Λ}}}_{{n}_{R} , {n}_{T}}^{m}$$

is a diagonal matrix composed of the frequency-domain channel response between the m-th user's antenna n_{T} and the base station antenna n_{R}.

The generalized input/output matrix model that relates the STBC coded symbol vector defined as
s[n]:=[s¹[n]^{T} . . . s^{M}[n]^{T}]^{T} (eq. 14)
with for each user m (m=1, . . . , M):
s^{m}[n]:=[s₁^{m}[n]^{T} . . . s_{N}_{_{T}}^{m}[n]^{T}]^{T} (eq. 15)
to the received and noise vectors defined as
y[n]:=[y₁[n]^{T} . . . y_{N}_{_{R}}[n]^{T}]^{T} (eq. 16)
z[n]:=[z₁[n]^{T} . . . z_{N}_{_{R}}[n]^{T}]^{T} (eq. 17)
is given by
y[n]=H·θ·s[n]+z[n] (eq. 18)
where the channel matrix is

$$\begin{matrix}\underline{\underline{H}} \text{:} = [ \begin{matrix}{\underline{\underline{H}}}_{1}^{1} & ⋯ & {\underline{\underline{H}}}_{1}^{M} \\ ⋮ & ⋮ & ⋮ \\ {\underline{\underline{H}}}_{{N}_{R}}^{1} & ⋯ & {\underline{\underline{H}}}_{{N}_{R}}^{M}\end{matrix} ] \\ with & ( eq . 19 ) \\ {\underline{\underline{H}}}_{{n}_{R}}^{m} \text{:} = [ \begin{matrix}{\underline{\underline{H}}}_{{n}_{R} , 1}^{m} & ⋯ & {\underline{\underline{H}}}_{{n}_{R} , {N}_{T}}^{m}\end{matrix} ] ( m = 1 , … , M ; {n}_{R} = 1 , … , {N}_{R} ) \\ and & ( eq . 20 ) \\ \underline{\underline{θ}} \text{:} = [ \begin{matrix}{\underline{\underline{I}}}_{{N}_{T}} ⊗ {\underline{\underline{θ}}}^{1} & ⋯ & {\underline{\underline{0}}}_{{N}_{T} Q \times {N}_{T} B} \\ ⋮ & ⋰ & ⋮ \\ {\underline{\underline{0}}}_{{N}_{T} Q \times {N}_{T} B} & ⋯ & {\underline{\underline{I}}}_{{N}_{T}} ⊗ {\underline{\underline{θ}}}^{M}\end{matrix} ] . & ( eq . 21 )\end{matrix}$$

Taking (1) and (2) into account, the model (18) is extended to the STBC input/output matrix model
y_{stbc}[i]=H_{stbc}·θ_{stbc}·χ_{stbc}·e[i]+z_{stbc}[i] (eq. 22)
where the vector of transmitted symbols is defined as (N_{T}=2)
d[i]:=[d¹[i]^{T} . . . d^{M}[i]^{T}]^{T} (eq. 23)
with
d^{m}[i]:=[d₁^{m}[i]^{T} . . . d_{N}_{_{T}}^{m}[i]^{T}]^{T} (m=1, . . . , M) (eq. 24)
and the received and noise vectors are defined as

$$\begin{matrix}{\underline{y}}_{stbc} [ i ] \text{:} = [ \begin{matrix}\underline{y} [ n ] \\ {\underline{y} [ n + 1 ]}^{*}\end{matrix} ] & ( eq . 25 ) \\ {\underline{z}}_{stbc} [ i ] \text{:} = [ \begin{matrix}\underline{z} [ n ] \\ {\underline{z} [ n + 1 ]}^{*}\end{matrix} ] \\ where i = \vert n / 2 \vert , and & ( eq . 26 ) \\ {\underline{\underline{χ}}}_{stbc} \text{:} = [ \begin{matrix}{\underline{\underline{I}}}_{{MN}_{T} B} \\ {\underline{\underline{I}}}_{M} ⊗ \underline{\underline{χ}}\end{matrix} ] & ( eq . 27 ) \\ {\underline{\underline{θ}}}_{stbc} \text{:} = [ \begin{matrix}\underline{\underline{θ}} & {\underline{\underline{0}}}_{{MN}_{T} Q \times {MN}_{T} B} \\ {\underline{\underline{0}}}_{{MN}_{T} Q \times {MN}_{T} B} & {\underline{\underline{θ}}}^{*}\end{matrix} ] & ( eq . 28 ) \\ {\underline{\underline{H}}}_{stbc} \text{:} = [ \begin{matrix}\underline{\underline{H}} & {\underline{\underline{0}}}_{{N}_{R} MQ \times {MN}_{T} Q} \\ {\underline{\underline{0}}}_{{N}_{R} MQ \times {MN}_{T} Q} & {\underline{\underline{H}}}^{*}\end{matrix} ] . & ( eq . 29 )\end{matrix}$$

The received vector is formed by the juxtaposition of the vector received at the first time instant with the conjugate of the vector received at the second time instant.

In order to detect transmitted symbol block d^{p}[i] of the p-th user, based on the received sequence of blocks within the received vector y_{stbc}[i] a first solution consists of using a single-user receiver, that inverts successively the channel and all the operations performed at the transmitter. The single-user receiver relies implicitly on the fact that CDMA spreading has been applied on top of a channel equalized in the frequency domain. After CDMA de-spreading, each user stream is handled independently. However the single-user receiver fails in the uplink where multiple channels have to be inverted at the same time.

The optimal solution is to jointly detect the transmitted symbol blocks of the different users within the transmitted vector, d[i], based on the received sequence of blocks within the received vector, y_{stbc}[i]. The optimum linear joint detector according to the MMSE criterion is computed in Klein et al. (‘Zero forcing and minimum mean-square-error equalization for multiuser detection in code-division multiple-access channels’, IEEE Trans. on Veh. Tech., vol. 14, no. 9, pp. 1784-1795, December 1996). At the output of the MMSE multi-user detector, the estimate of the transmitted vector is given by the expression:

$$\begin{matrix}\underline{d} [ i ] = {( \frac{{σ}_{w}^{2}}{{σ}_{d}^{2}} {\underline{\underline{I}}}_{{MN}_{T} B} + {\underline{\underline{G}}}_{stbc}^{H} \cdot {\underline{\underline{G}}}_{stbc} )}^{- 1} \cdot {\underline{\underline{G}}}_{stbc}^{H} \cdot {\underline{y}}_{stbc} [ i ] \\ where & ( eq . 30 ) \\ {\underline{\underline{G}}}_{stbc} \text{:} = {\underline{\underline{H}}}_{stbc} \cdot {\underline{\underline{θ}}}_{stbc} \cdot {\underline{\underline{χ}}}_{stbc} . & ( eq . 31 )\end{matrix}$$

The MMSE linear joint detector consists of two main operations:
First, a filter matched to the composite impulse responses multiplies the received vector in order to minimise the impact of the white noise. The matched filter consists of the maximum ratio combining (MRC) of the different received antenna channels compensating the phase introduced by the channel, the CDMA intra-block de-spreading and the STBC de-coding.
Second, the output of the matched filter is still multiplied with the inverse of the composite impulse response auto-correlation matrix of size MN_{T}B that mitigates the remaining inter-symbol, inter-user and inter-antenna interference and compensates the amplitude variation introduced by the channel.

The linear MMSE receiver is different from the single-user receiver and suffers from a higher computational complexity. Fortunately, both the initialization complexity, which is required to compute the MMSE receiver, and the data processing complexity can be significantly reduced by exploiting the initial cyclo-stationarity property of the channels. Based on a few permutations and on the properties of the block circulant matrices, it is shown in the next sections that the initial inversion of the square auto-correlation matrix of size MN_{T}B can be replaced by the inversion of B square auto-correlation matrices of size MN_{T}.

Based on (19) and (21), one has that

$$\underline{\underline{H}} \cdot \underline{\underline{θ}} = [ \begin{matrix}{\underline{\underline{H}}}_{1}^{1} \cdot ( {\underline{\underline{I}}}_{{N}_{T}} ⊗ {\underline{\underline{θ}}}^{1} ) & ⋯ & {\underline{\underline{H}}}_{1}^{M} \cdot ( {\underline{\underline{I}}}_{{N}_{T}} ⊗ {\underline{\underline{θ}}}^{M} ) \\ ⋮ & ⋰ & ⋮ \\ {\underline{\underline{H}}}_{{N}_{R}}^{1} \cdot ( {\underline{\underline{I}}}_{{N}_{T}} ⊗ {\underline{\underline{θ}}}^{1} ) & ⋯ & {\underline{\underline{H}}}_{{N}_{R}}^{M} \cdot ( {\underline{\underline{I}}}_{{N}_{T}} ⊗ {\underline{\underline{θ}}}^{M} )\end{matrix} ] \qquad ( eq . 32 )$$

which can be interestingly reorganized based on two consecutive permutations.

First, each user m and receive antenna n_{R} inner matrix can be reorganized as
Hₙ_{_{R}}^{m}·(I_{N}_{_{T}}\textcircled{×}θ^{m})=Ψₙ_{_{R}}^{m}·Υ_{N}_{_{T}} (eq. 33)
where Υ_{N}_{_{T}} is a permutation matrix of size N_{T}B, the role of which is to reorganize the columns of the initial matrix Hₙ_{_{R}}^{m}·(I_{N}_{_{T}}\textcircled{×}θⁿ) according to the symbol and transmit antenna indexes successively, and
Ψₙ_{_{R}}^{m}:=[ψₙ_{_{R}}^{m}(1) . . . ψₙ_{_{R}}^{m}(B)] (eq. 34)
in which the submatrix ψₙ_{_{R}}^{m}:=(1):=[ψₙ_{_{R}}_{,1}^{m}(1) . . . ψₙ_{_{R}}_{,N}_{_{T}}^{m}(1)] of size Q×N_{T} is composed by the N_{T} transmit antenna channel impulse responses (CIRs) convolved with the user code m, and each submatrix ψₙ_{_{R}}^{m} (b) of size Q×N_{T} is a (b−1)N cyclic rotation of the matrix ψₙ_{_{R}}^{m}(1) (b=1, . . . , B), where N still represents the spreading code length.

Second, each receive antenna n_{R} inner matrix can be reorganized as
[Hₙ_{_{R}}¹·(I_{N}_{_{T}}\textcircled{×}θ¹) . . . Hₙ_{_{R}}^{M}·(I_{N}_{_{T}}\textcircled{×}θ^{M})]=Ψₙ_{_{R}}·Υ_{M}·(I_{M}\textcircled{×}Υ_{N}_{_{T}}) (eq. 35)
where Υ_{M} is a permutation matrix of size MN_{T}B, the role of which is to reorganize the columns of the initial matrix [Hₙ_{_{R}}¹·(I_{N}_{_{T}}\textcircled{×}θ¹) . . . Hₙ_{_{R}}^{M}·(I_{N}_{_{T}}\textcircled{×}θ^{M})] according to the symbol, user and transmit antenna indexes successively and
Ψₙ_{_{R}}:=[ψₙ_{_{R}}(1) . . . ψₙ_{_{R}}(B)] (eq. 36)
with ψₙ_{_{R}}(b):=[ψₙ_{_{R}}¹(b) . . . ψₙ_{_{R}}^{M}(b)].

The block circulant matrix Ψₙ_{_{R}} can be decomposed into (see the above-mentioned Vollmer paper)
Ψₙ_{_{R}}=F_{(N)}^{H}·Φₙ_{_{R}}·F_{(MN}_{_{T}}₎ (eq. 37)
where the matrices F_{(M)} and F_{(MN}_{_{T}}₎ are block Fourier transforms defined as
F₍ₙ₎:=F_{R}\textcircled{×}Iₙ (eq. 38)
where F_{R} is the orthogonal Fourier transform matrix of size B and Iₙ is the identity matrix =B of size n (n equal to N or MN_{T}). The inner matrix Φₙ_{_{R}} equals

$${\underline{\underline{Φ}}}_{{n}_{R}} \text{:} = [ \begin{matrix}{\underline{\underline{ϕ}}}_{{n}_{R}} ( 1 ) & ⋯ & {\underline{\underline{0}}}_{N \times {MN}_{T}} \\ ⋮ & ⋰ & ⋮ \\ {\underline{\underline{0}}}_{N \times {MN}_{T}} & ⋯ & {\underline{\underline{ϕ}}}_{{n}_{R}} ( B )\end{matrix} ] \qquad ( eq . 39 )$$

where the block diagonal is found by dividing the result of the product F_{(N)}φₙ_{_{R}} (1) into blocks φₙ_{_{R}} (b) of size N×MN_{T} (b=1, . . . , B), each block representing one of B user-independent and transmit antenna-independent sub-channels present in the communication.

Finally one gets

$$\begin{matrix}\underline{\underline{H}} \cdot \underline{\underline{θ}} = ( {\underline{\underline{I}}}_{{N}_{R}} ⊗ {\underline{\underline{F}}}_{( N )}^{H} ) \cdot \underline{\underline{Ψ}} \cdot {\underline{\underline{F}}}_{( {MN}_{T} )} \cdot \underline{\underline{Υ}} \\ where & ( eq . 40 ) \\ \underline{\underline{Ψ}} \text{:} = [ \begin{matrix}{\underline{\underline{Φ}}}_{1} \\ ⋮ \\ {\underline{\underline{Φ}}}_{{N}_{R}}\end{matrix} ] & ( eq . 41 ) \\ \underline{\underline{Υ}} \text{:} = {\underline{\underline{Υ}}}_{M} \cdot ( {\underline{\underline{I}}}_{M} ⊗ {\underline{\underline{Υ}}}_{{N}_{T}} ) & ( eq . 42 )\end{matrix}$$

Taking into account the matrix definitions (27), (28), (29) and applying then in (31) one gets

$${\underline{\underline{G}}}_{stbc} \text{:} = [ \begin{matrix}\underline{\underline{H}} & {\underline{\underline{0}}}_{{N}_{R} MQ \times {MN}_{T} Q} \\ {\underline{\underline{0}}}_{{N}_{R} MQ \times {MN}_{T} Q} & {\underline{\underline{H}}}^{*}\end{matrix} ] \cdot [ \begin{matrix}\underline{\underline{θ}} & {\underline{\underline{0}}}_{{MN}_{T} Q \times {MN}_{T} B} \\ {\underline{\underline{0}}}_{{MN}_{T} Q \times {MN}_{T} B} & {\underline{\underline{θ}}}^{*}\end{matrix} ] \cdot [ \begin{matrix}{\underline{\underline{I}}}_{{MN}_{T} B} \\ {\underline{\underline{I}}}_{M} ⊗ \underline{\underline{χ}}\end{matrix} ] . \qquad ( eq . 43 )$$

Multiplying the first two matrices and relying on the permutation (40) one obtains

$${\underline{\underline{G}}}_{stbc} \text{:} = [ \begin{matrix}( {\underline{\underline{I}}}_{{N}_{R}} ⊗ {\underline{\underline{F}}}_{( N )}^{H} ) \cdot \underline{\underline{Ψ}} \cdot {\underline{\underline{F}}}_{( {MN}_{T} )} \cdot \underline{\underline{Υ}} & {}_{{N}_{R} MQ \times {MN}_{T} B} \\ {\underline{\underline{0}}}_{{N}_{R} MQ \times {MN}_{T} B} & ( {\underline{\underline{I}}}_{{N}_{R}} ⊗ {\underline{\underline{F}}}_{( N )}^{T} ) \cdot {\underline{\underline{Ψ}}}^{*} \cdot {\underline{\underline{{F}^{*}}}}_{( {MN}_{T} )} \cdot {\underline{\underline{Υ}}}^{*}\end{matrix} ] \cdot [ \begin{matrix}{\underline{\underline{I}}}_{{MN}_{T} B} \\ {\underline{\underline{I}}}_{M} ⊗ \underline{\underline{χ}}\end{matrix} ] \qquad ( eq . 44 )$$

from which the term inside the inversion in the MMSE expression (30) can be computed as follows

$${\underline{\underline{G}}}_{stbc}^{H} \cdot {\underline{\underline{G}}}_{stbc} = {\underline{\underline{Υ}}}^{H} \cdot {\underline{\underline{F}}}_{( {MN}_{T} )}^{H} \cdot {\underline{\underline{Ψ}}}^{H} \cdot \underline{\underline{Ψ}} \cdot {\underline{\underline{F}}}_{( {MN}_{T} )} \cdot \underline{\underline{Υ}} + ( {\underline{\underline{I}}}_{M} ⊗ {\underline{\underline{χ}}}^{H} ) \cdot {\underline{\underline{Υ}}}^{T} \cdot {\underline{\underline{F}}}_{( {MN}_{T} )}^{T} \cdot {\underline{\underline{Ψ}}}^{T} \cdot {\underline{\underline{Ψ}}}^{*} \cdot {\underline{\underline{F}}}_{( {MN}_{T} )}^{*} \cdot {\underline{\underline{Υ}}}^{*} \cdot ( {\underline{\underline{I}}}_{M} ⊗ \underline{\underline{χ}} ) \qquad ( eq . 45 )$$

In equation (45) the STBC coding matrix can be reorganized taking into account that
(I_{M}\textcircled{×}χ^{H})·Υ^{T}·F_{(MN}_{_{T}}₎^{T}=Υ^{T}·F_{*MN}_{_{T}}₎^{T}·(I_{BM}\textcircled{×}χ*_{N}_{_{T}}) (eq. 46)
yielding an equivalent expression with a lower inversion complexity
=Υ^{H}·F_{(MN}_{_{T}}₎^{H}·(Ψ^{H}·Ψ+(I_{BM}\textcircled{×}χ*_{N}_{_{T}})·Ψ^{T}·Ψ*·(I_{BM}\textcircled{×}χ_{N}_{_{T}}))·F_{(MN}_{_{T}}₎·Υ (eq. 47)

The inner matrix in (47) is a block diagonal matrix where each block, of size MN_{T}×MN_{T}, corresponds to a symbol b. Identifying the subpart of size N_{T}×N_{T} of each block corresponding to the users m₁ and m₂, it is equal to

$${\sum }_{{n}_{R} = 1}^{{N}_{R}} [ \begin{matrix}{{\underline{ψ}}_{{n}_{R} , 1}^{{m}_{1}} ( b )}^{H} \cdot {\underline{ψ}}_{{n}_{R} , 1}^{{m}_{2}} ( b ) + {{\underline{ψ}}_{{n}_{R} , 2}^{{m}_{2}} ( b )}^{T} \cdot {{\underline{ψ}}_{{n}_{R} , 2}^{{m}_{1}} ( b )}^{*} & {{\underline{ψ}}_{{n}_{R} , 1}^{{m}_{1}} ( b )}^{H} \cdot {\underline{ψ}}_{{n}_{R} , 2}^{{m}_{2}} ( b ) - {{\underline{ψ}}_{{n}_{R} , 2}^{{m}_{2}} ( b )}^{T} \cdot {{\underline{ψ}}_{{n}_{R} , 1}^{{m}_{1}} ( b )}^{*} \\ {{\underline{ψ}}_{{n}_{R} , 2}^{{m}_{1}} ( b )}^{H} \cdot {\underline{ψ}}_{{n}_{R} , 1}^{{m}_{2}} ( b ) - {{\underline{ψ}}_{{n}_{R} , 1}^{{m}_{2}} ( b )}^{T} \cdot {{\underline{ψ}}_{{n}_{R} , 2}^{{m}_{1}} ( b )}^{*} & {{\underline{ψ}}_{{n}_{R} , 2}^{{m}_{1}} ( b )}^{H} \cdot {\underline{ψ}}_{{n}_{R} , 2}^{{m}_{2}} ( b ) + {{\underline{ϕ}}_{{n}_{R} , 1}^{{m}_{2}} ( b )}^{T} \cdot {{\underline{ϕ}}_{{n}_{R} , 1}^{{m}_{1}} ( b )}^{*}\end{matrix} ] \qquad ( eq . 48 )$$

which is a diagonal matrix only if m₁=m₂.

As a result of (47) and (48), the linear matched filter allows for optimal combining of the signals coming from the two transmit antennas and complete inter-antenna interference removal for each user independently. The high complexity inversion of the inner equalization matrix reduces to the inversion of B complex Hermitian matrices of size MN_{T}, that are to be multiplied with the matched filter output in order to mitigate the remaining inter-user interference.

Based on (40) and (47), the MMSE multi-user joint detection decomposes into the successive operations (see FIG. 4). The method steps are explained for an example with two transmit antennas.
A. separation of the received stream of block coded data in a number of STBC data streams equal to the STBC coding length at the transmitter; with 2 Tx antennas this obviously yields two received STBC data streams.
B. performing a transformation composed of FFT operations of a size equal to the data block size (B),
C. maximum ratio combining (MRC) of the different receive antenna signals and CDMA despreading,
D. STBC decoding by combining the different received data streams,
E. mitigation of the inter-user, inter-antenna interference by multiplication with the inner matrix,
F. IFFT to bring the output data to the time domain,
G. permutation to arrange the result according to the user, transmit antenna and symbol indexes successively.

The separation operation as described above may be performed by a separating module (not shown). The separating module is configured to separate the received block coded data in a number of data streams. The decoding operation as described above may be performed by a decoding module (not shown). The mitigation of interference as described above may be performed by an interference cancellation module which is configured to cancel interference on a sub-channel per sub-channel basis. An operation of block despreading comprising the permutation (G) as described above may be performed by a despreading module (not shown). In some embodiments, each of the separating module, the decoding module, the interference cancellation module, and the despreading module may be a processor which may be any suitable general purpose single- or multi-chip microprocessor, or any suitable special purpose microprocessor such as a digital signal processor, microcontroller, or a programmable gate array. As is conventional, the processor may be configured to execute one or more software modules. In some embodiments, two or more of these modules may be combined into one module.

At the output of the STBC decoding, the two transmit antenna streams are perfectly orthogonalized for each user independently.

If the environment is dynamic, the receiver can be slightly adapted to take the variation of the propagation channels into account. FIG. 5 shows the modified scheme. The matrix Ψ, until now assumed to be constant in time, can be updated over the successive time instants. Taking again the example of a two-antenna scheme, which was already discussed previously, this gives rise to the matrices Ψ₁ and Ψ₂, relative respectively to the time instants 1 and 2.

The complexity required at the base station to compute the multi-user receiver during the initialization phase is given in Table 1. The two main operations are detailed: the inner matrix computation and the inversion of the inner matrix. A significant gain of initialization complexity is achieved by computing the MMSE joint detector in the frequency domain (using the result (40)) instead of in the time domain (using the initial expression (30)).

TABLE I

| | Time domain | Frequency domain |
|---|---|---|
| Inner product | 2NB³M³(N_{R}N_{T}) | 2NBM²(N_{R}N_{T}²) |
| Inversion | 2B³M³N³T | 2BM³N³T |

The complexity needed during the data processing phase to receive each transmitted complex symbol block is further given in the Table 2. While additional FFT and IFFT operations are required to move to the frequency domain and back to the time domain, the data processing complexity required to mitigate the inter-user and inter-antenna interference is lower in case of frequency domain processing.

TABLE II

| | Time domain | Frequency domain |
|---|---|---|
| FFT | — | 2NN_{R}Blog₂B |
| Interference mitigation | 2NB²M²(N_{R}N_{T}) | 2NB²M(N_{R}N_{T}) |
| IFFT | — | MN_{T}Blog₂B |

Now the gain obtained by using STBC coding at the transmitter is evaluated in the uplink of a realistic cellular system. The propagation environment is modeled by a tapped delay line channel model, where each tap is assumed to have a Rayleigh distribution. Monte-Carlo simulations have been performed to average the bit error rate (BER) over 500 stochastic channel realizations.

The system parameters are summarized in Table III. A static cellular system is considered, which operates in an outdoor propagation environment. This propagation environment is modeled by the ITU Vehicular Type A model, which is characterized by specular multipath (coming from discrete, coherent reflections from smooth metal surfaces) with a maximum excess delay of 2510 ns.

TABLE III

| Channel model | ITU Vehicular Type A |
|---|---|
| Carrier frequency | 2 GHz |
| Signaling rate | 5 MHz |
| Roll-off | 0.2 |
| Spreading factor | SF = 8 |
| Modulation format | QPSK |
| Number of subcarriers | Q = 64 |
| Cyclic prefix length | L = 16 |
| Convolutional code rate | ¾ |

### Static Cellular System Parameters

The system operates at a carrier frequency of 2 GHz, with a system bandwidth of 5 MHz. The transmitted signals are shaped with a half-rooth Nyquist in order to limit the bandwidth. A roll-off factor equal to 0.2 has been assumed.

The information bandwidth is spread by a spreading factor (SF) equal to SF=8. The number of users active in the system varies from I (low system load) to 8 (high system load). The user signals are spread by periodic Walsh-Hadamard codes for spreading, which are overlaid with an aperiodic Gold code for scrambling. QPSK modulation is used with Q=64 subchannels, and a cyclic prefix length of L=16. A convolutional code with a rate of 3/4 is applied on each user bit stream separately.

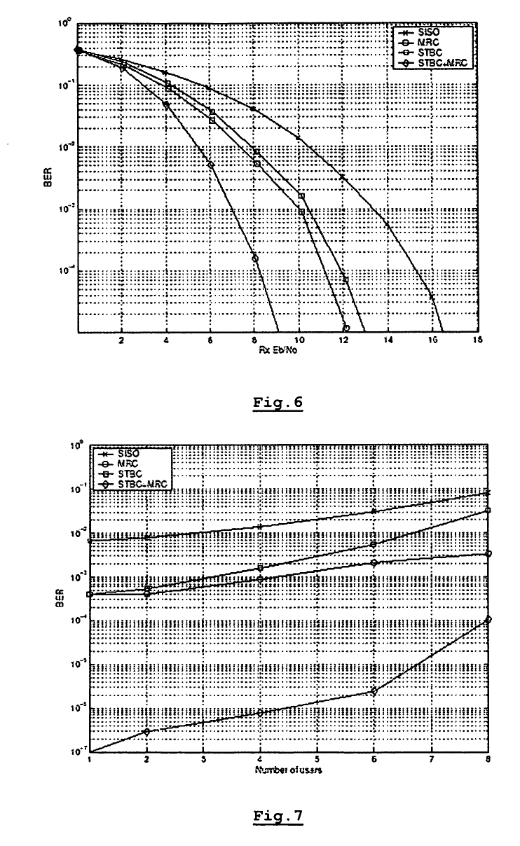

FIG. 6 compares the diversity gain obtained by the use of multiple antennas at each side of the link. A typical system load of 4 users is assumed. A significant gain is achieved when diversity is exploited by the use of two antennas at only one side of the link (STBC or MRC is used). A supplementary gain can be obtained if two antennas are available at both sides (STBC is used in combination to MRC). It can be observed that MRC slightly outperforms STBC.

FIG. 7 shows the impact of the system load on the SNR gain obtained by the use of multiple antennas. An SNR equal to 10 dB is assumed. In case of STBC, it has been analytically proven that the inter-antenna interference of the user of interest is totally cancelled. However, STBC still relies on the good orthogonality properties of the CDMA codes and on joint detection to handle the inter-antenna interference coming from the other users. MRC does not suffer from this effect since it is applied at the receiver. When only one user is active in the system, STBC and MRC perform equally well. However, the gap between STBC and MRC increases with the number of users active in the system due to the increasing level of interference coming from the other users.

The foregoing merely illustrates the principles of the invention. It will thus be appreciated that those skilled in the art will be able to device numerous other systems which embody the principles of the invention and are thus within its spirit and scope.

Finally, although systems and methods as disclosed, is embodied in the form of various discrete functional blocks, the system could equally well be embodied in an arrangement in which the functions of any one or more of those blocks or indeed, all of the functions thereof, are realized, for example, by one or more appropriately programmed processors or devices.

What is claimed is:

1. A method for wireless transmission of a sequence of data symbols from a transmitter to a receiver, the transmitter being provided with at least two transmit antennas, comprising:
converting the sequence of data symbols into at least one stream of blocks of independent data symbols to be transmitted,
performing a block coding operation on the at least one stream of data symbol blocks, yielding a coded block of data symbols on each of the at least two antennas,
applying a spreading operation on each data symbol of the coded block of data symbols, yielding spread coded blocks,
adding transmit redundancy to the spread coded blocks, and
transmitting the spread coded blocks with transmit redundancy.

2. The method for wireless transmission as in claim 1, wherein the block coding operation comprises a space-time block coding operation.

3. The method for wireless transmission as in claim 1, wherein the method is performed for a plurality of users, each user being connected to a user-specific terminal.

4. The method for wireless transmission as in claim 1, wherein the spreading operation is performed with a user-specific code sequence.

5. The method for wireless transmission as in claims 1, wherein the adding transmit redundancy comprises adding a cyclic prefix.

6. The method for wireless transmission as in claim 1, wherein the transmitter provided with at least two antennas comprises a terminal and the receiver comprises a base station.

7. The method for wireless reception of block coded data transmitted, for a plurality of users, by a plurality of transmitters, each of the transmitters being provided with at least two transmit antennas, comprising:
separating the received block coded data in a number of received data streams, the number dependent on the block coding applied on the blocks of data in the transmitters, the received data streams comprising block coded blocks of data from different users and different transmit antennas, and
performing computation on the block coded blocks of data comprised in the number of received data streams to order the received data per user and per transmit antenna, the computation comprising a block decoding and an intrablock despreading operation, whereby the computation step divides each of the block coded blocks of data into sub-channels, the block coded blocks of data subsequently being combined per sub-channel, yielding a single combined data stream of per sub-channel blocks of data, ordered per user and per transmit antenna.

8. The method for wireless reception as in claim 7, further comprising:
cancelling interference by combining, for each of the sub-channels, data in the single combined data stream of per sub-channel blocks of data corresponding to only one sub-channel, yielding interference cancelled per sub-channel blocks of output data,
transforming the interference cancelled per sub-channel blocks of output data over all sub-channels, yielding transformed blocks of output data, and
reordering the transformed blocks of output data per user and per transmit antenna.

9. The method for wireless reception as in claim 7, wherein the dividing into sub-channels comprises a plurality of fast Fourier transforms.

10. The method for wireless reception as in claim 8, wherein the transforming comprises an inverse fast Fourier transform operation.

11. The method for wireless reception as in any of claims 7, wherein the computation comprises a phase correction on each of the sub-channels.

12. The method for wireless reception as in claim 7, wherein the interference cancellation comprises an amplitude equalization on each of the sub-channels.

13. The method for wireless reception as in claim 7, wherein a plurality of receive antennas is used for receiving the block coded data.

14. A transmit device for wireless communication configured to perform the method for wireless transmission of claim 1.

15. A transmit device for wireless transmission of at least one stream of blocks of data, the transmit device being provided with at least two transmit antennas, the transmit device comprising:
block coding means to perform a block coding operation on the at least one stream of blocks of data, the block coding means outputting a coded block of data on each of the at least two antennas; and
spreading means to spread the coded block of data on each of the at least two antennas.

16. A receiver device for wireless communication configured to perform the method for wireless reception of claim 7.

17. A receiver device for wireless reception of block coded data transmitted, for a plurality of users, by a plurality of transmitters, each of the transmitters being provided with at least two transmit antennas, the receive device comprising:
at least one receive antenna, separating means for separating the received block coded data in a number of received data streams, and means for block decoding and block despreading for each of the received data streams.

18. The receiver device as in claim 17, further comprising interference cancellation means arranged for cancelling interference on a sub-channel per sub-channel basis.

19. A transmitter comprising a processor which executes software code configured to:
convert the sequence of data symbols into at least one stream of blocks of independent data symbols to be transmitted,
perform a block coding operation on the at least one stream of data symbol blocks, yielding a coded block of data symbols on each of the at least two antennas,
apply a spreading operation on each data symbol of the coded block of data symbols, yielding spread coded blocks,
add transmit redundancy to the spread coded blocks, and
transmit the spread coded blocks with transmit redundancy.

20. The transmitter of claim 19, wherein the block coding operation comprises a space-time block coding operation.

21. The transmitter of claim 19, wherein the transmitter operates for a plurality of users, each user being connected to a user-specific terminal.

22. The transmitter of claim 19, wherein the spreading operation is performed with a user-specific code sequence.

23. The transmitter of claim 19, wherein the addition of transmit redundancy comprises adding a cyclic prefix.

24. The transmitter of claim 19, wherein the transmitter provided with at least two antennas comprises a terminal.

25. A receiver comprising a processor which executes software code configured to:
separate the received block coded data in a number of received data streams, the number dependent on the block coding applied on the blocks of data in the transmitters, the received data streams comprising block coded blocks of data from different users and different transmit antennas, and
perform computation on the block coded blocks of data comprised in the number of received data streams to order the received data per user and per transmit antenna, the computation comprising a block decoding and an intrablock despreading operation, whereby the computation divides each of the block coded blocks of data into sub-channels, the block coded blocks of data subsequently being combined per sub-channel, yielding a single combined data stream of per sub-channel blocks of data, ordered per user and per transmit antenna.

26. The receiver of claim 25, further configured to:
cancel interference by combining, for each of the sub-channels, data in the single combined data stream of per sub-channel blocks of data corresponding to only one sub-channel, yielding interference cancelled per sub-channel blocks of output data,
transform the interference cancelled per sub-channel blocks of output data over all sub-channels, yielding transformed blocks of output data, and
reorder the transformed blocks of output data per user and per transmit antenna.

27. The receiver of claim 25, wherein the dividing into sub-channels comprises a plurality of fast Fourier transforms.

28. The receiver of claim 26, wherein the transformation comprises an inverse fast Fourier transform operation.

29. The receiver of claim 25, wherein the computation comprises a phase correction on each of the sub-channels.

30. The receiver of claim 25, wherein the interference cancellation comprises an amplitude equalization on each of the sub-channels.

31. The receiver of claim 25, wherein a plurality of receive antennas is used for receiving said block coded data.
